(19) United States
(12) Patent Application Publication
(10) Pub. No.: US 2007/0002976 A1
(43) Pub. Date: Jan. 4, 2007

(54) Method of recording a stream of audio-visual data

(75) Inventors: Wilhelmus F. J. Fontijn, Eindhoven (NL); Robert Jochemsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninkijke phillips electronics n.v.

(21) Appl. No.: 10/539,319

(22) PCT Filed: Nov. 20, 2003
(86) PCT No.: PCT/IB03/05471

§ 371 Date: Jun. 15, 2005

(30) Foreign Application Priority Data
Dec. 20, 2002 (EP) 02080511.5

(51) Int. Cl. H04L 27/06

(52) U.S. Cl. 375/340

(57) ABSTRACT

When a stream of audio-visual data like a television program is recorded (110) with a digital video recorder comprising a compression engine (113) for compressing the stream prior to storage using a variable bit-rate compression technique, the size of the full stream to be stored is unknown. The invention provides a method which solves this problem by providing information on the complexity of the stream to be stored. With this information, combined with information on the duration of the stream of audio-visual data and the compression algorithm used to compress the stream, the amount of storage space to be reserved for storing the stream of audio-visual data can be determined.

The invention relates to a method of determining the size of a compressed stream of audio-visual data, wherein the compression has taken place by means of variable bit-rate compression, the method comprising the step of determining the duration of the stream of audio-visual data.

The invention further relates to a circuit for determining the size of a compressed stream of audio-visual data, wherein the compression has taken place by means of variable bit-rate compression, the circuit comprising a central processing unit conceived to determine the duration of the stream of audio-visual data.

The invention also relates to an apparatus for storing a stream of audio-visual data, the apparatus comprising a compression controller for compressing the stream of audio-visual data prior to storage of the stream of audio-visual data.

The invention relates as well to a signal carrying a stream of audio-visual data and meta-data associated with the stream of audio-visual data.

U.S. Pat. No. 6,188.650 describes an apparatus for recording a data on a medium. A user is enabled to specify a recording start time, a recording end time, the bit rate of a bit stream and a channel to be recorded in advance. From this information, the file size is calculated and recording area on the medium is reserved.

A problem of this apparatus is that when the stream of audio-visual data is compressed prior to storage and compression takes place in accordance with a variable bit-rate compression algorithm, the exact bit rate and therefore the exact size of the (future) stored program is not known; there is only a rough estimate.

It is an object of the invention to provide a method allowing a more accurate estimate of the size of the stored stream of audio-visual data, when the stream of audio-visual data is compressed in accordance with a variable bit-rate compression algorithm.

This object is achieved with the method according to the invention and is characterized in that the method further comprises the following steps: determining the compression technique; determining the complexity of the stream of audio-visual data; and determining the size of the stream of audio-visual data using the information determined in the previous steps.

The average bit rate of a stream of audio-visual data is determined by the complexity of the stream of audio-visual data. When the complexity is low, the stream comprises little information, like a test screen for the full duration of the stream. With a high complexity, the stream comprises all different pictures. In the first case, the average bit rate of the compressed stream will be lower than when the stream of the second case is compressed, even when in both cases the same variable bit-rate compression technique is used, with the same quality level. The complexity of the stream of audio-visual data may be indicated in various ways, as will be apparent from various embodiments of the invention that will be described hereinafter.

An average bit rate may thus be determined from the compression technique and the complexity of the stream. The size of the stream to be stored can be determined from information on the duration of the stream.

In an embodiment of the method according to the invention, the complexity of the stream of audio-visual data is indicated by a factor of information redundancy in the stream of audio-visual data

In this way, the invention may be used for all kinds of variable bit-rate compression techniques. It may not provide the exact size of the compressed stream of audio-visual data for all compression techniques, but will provide a good estimate.

In a further embodiment of the method according to the invention, the complexity of the stream of audio-visual data is derived from meta-data associated with the stream of audio-visual data.

This embodiment provides an apparatus using the method according to the invention with the information needed to carry out the method according to the invention in an easy way. The information may even be supplied prior to reception of the stream of audio-visual data.

In yet another embodiment of the method according to the invention, the size of the stream of audio-visual data is determined prior to reception of the full stream of audio-visual data.

Using this embodiment of the invention, one contiguous area in a memory where the stream needs to be stored may be allocated for storage of the stream. This is advantageous for embodiments of the invention where the memory is a disc-based memory. When the stream is stored in one contiguous area, it can be retrieved continuously, without sweeping of the pick-up unit. This improves the performance of the disc-based memory, because no data can be read when sweeping the pick-up unit.

The circuit according to the invention is characterized in that the central processing unit is further conceived to: determine the compression technique used to compress the stream of audio-visual data; determine the complexity of the stream of audio-visual data; and determine the size of the stream of audio-visual data using the information on the duration of the stream of audio-visual data, the compression technique used to compress the stream of audio-visual data and the complexity of the stream of audio-visual data.

The apparatus according to the invention comprises the circuit as defined in claim 10.

The signal according to the invention is characterized in that the meta-data comprises information on the complexity of the stream of audio-visual data.

In an embodiment of the signal according to the invention, the information on the complexity of the stream of audio-visual data is provided prior to providing the stream of audio-visual data.

In this way, the size of the stream of audio-visual data to be stored can be determined prior to the reception and storage of the stream of audio-visual data.

These and other aspects of the invention will become apparent from the drawings, wherein:

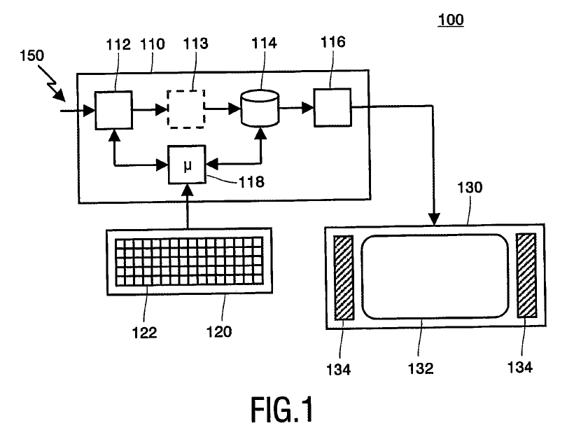

FIG. 1 shows a system comprising an apparatus as an embodiment of the apparatus according to the invention; and

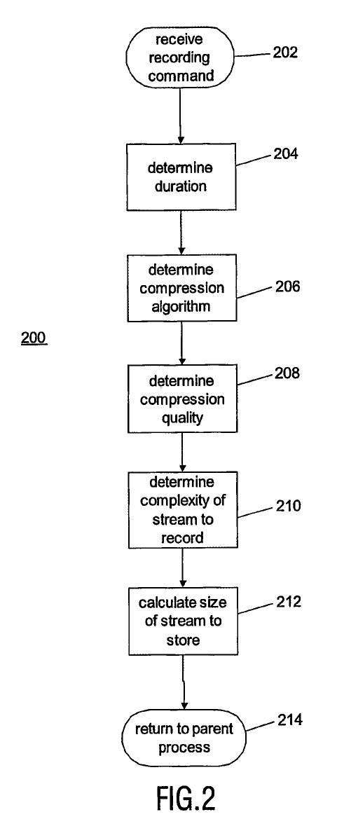

FIG. 2 shows a flow chart depicting an embodiment of the method according to the invention.

FIG. 1 shows a consumer electronics system 100 comprising a recording apparatus 110 as an embodiment of the apparatus according to the invention, a user input device 120 and a display device 130.

The recording device 110 comprises a reception unit 112 for receiving a broadcast signal 150. The broadcast signal 150 may be received by a satellite system, a cable channel or other means, but the invention is not limited to this. The reception unit 112 derives a stream of audio-visual data from the received broadcast signal 150 that is compliant with standards commonly used, i.e. PAL, SECAM or NTSC for analog television and DVB for digital television. The reception unit 112 comprises a tuner for selecting a channel. When an analog television signal is received, it is converted to a digital television signal by the reception unit 112.

A user of the system 100 may issue a recording command by means of user input device 120 comprising a keyboard 122 to order the recording apparatus 110 to record the received stream of audio-visual data.

Upon reception of the recording command, a central processing unit 118 commands a memory 114 to store the stream of audio-visual data. The memory 114 may be a hard disc or an optical disc like DVD or Blu Ray. The memory 114 may also be any other kind of recording medium including flash EEPROM and the like.

Prior to storage of the stream of audio-visual data, the stream is compressed in accordance with a variable bit-rate compression algorithm like MPEG2 by a compression unit 113.

The stored stream of audio-visual data can be shown on the display device 130. When doing so, the video part of the stream of audio-visual information is shown on the screen 132 and the audio part is reproduced by means of a pair of speakers 134.

When receiving a recording command to record a stream of audio-visual information in the memory 114, the size of the stream of audio-visual information is not always known beforehand. This is particularly the case when the recording is started by a manual input command and no end time of the recording has been set. It is therefore not known whether there is enough free space in the memory 114 to store the stream of audio-visual information to be recorded. One of the reasons for this is that the duration of the stream of audio-visual information is unknown.

Furthermore, with variable bit-rate compression, the average bit rate of the finally compressed and recorded stream is unknown when using methods according to the prior art. With variable bit-rate encoding, there is a lower boundary and an upper boundary of the average bit rate.

For a compression algorithm like MPEG-2, the lower boundary bit rate is the average bit rate of a compressed stream of audio-visual data continuously presenting the same image, like a test screen. In such a stream, only the first frame comprises information, the rest of the stream is redundant data.

The upper boundary bit rate is the average bit rate of a compressed stream of audio-visual data in which each frame in a GOP (Group of Pictures) is fully different from all other frames in the GOP. In such a stream, every frame comprises information, at least when considering a GOP.

Basically stated, the bit rate of a stream of audio-visual data compressed with a variable bit-rate compression algorithm depends on the amount of information in the stream or the complexity of the stream.

The lower and upper boundaries are determined by the compression technology (MPEG 2, MPEG-4, Div/X or the like) and the quality of the compressed stream. For MPEG-2, this is dependent on the number of DCT coefficients used during compression.

By supplying a parameter indicating the complexity of a compressed stream relative to the lower boundary on one side and the upper boundary on the other side (or relative to either one of them), an indication of the average bit rate of the compressed stream can be provided. In a preferred embodiment, this parameter is received with the broadcast signal 150 together with the stream of audio-visual data.

Taking the explanation above into account, the parameter is provided as a measure for data redundancy of the stream of audio-visual data in one embodiment. In a further embodiment, the parameter is provided as an average bit rate for a given compression algorithm and a given quality level of the compression. In a further embodiment of the invention, multiple parameters may be provided; one for each compression technique/algorithm.

This parameter, combined with the duration of the stream of audio-visual data, which is usually a single program, and information on the compression algorithm used to compress, the amount of data to be stored in the memory 114 can be determined. The parameter can be embedded in meta-data sent in compliance with, for example, MPEG-7, TV-Anytime or a proprietary protocol.

In a preferred embodiment, the information on the duration of the program is derived from an electronic program guide, also known as EPG. As an alternative, teletext may be used. The apparatus should know how to interpret a program guide on teletext (which page, how is the page built up). This may be provided by a user, but may also be built into the apparatus upon manufacture. The duration may also be derived from any other kind of meta-data like MPEG-7, TV-Anytime or a proprietary content description protocol. This information may be distributed along with the stream of audio-visual data, but also through other channels like the Internet or a telephone line.

When a recording of a stream of audio-visual data is pre-programmed in the recording apparatus 110, the duration of the program is already available in the recording apparatus 110 itself. The recording of the stream may be pre-programmed by an EPG protocol or by just setting a start time and an end time. Alignment of recording times with the program to be recorded may be enhanced using protocols like Program Delivery Control and Showview.

When the recording action is not pre-programmed and the recording is started by e.g. a manual operation by a user, the duration of the program to be recorded will have to be determined as described in a previous paragraph; by deriving, from meta-data, the information on the duration of the program currently showing.

FIG. 2 shows a flow chart 200 depicting an embodiment of the method according to the invention. The method depicted may be used as a sub-routine in a recording process.

The method starts at a starting point 202 when a command is received to record a television program and this sub-routine is called upon. Subsequently, the duration of the program is determined in accordance with one of the methods described above in a process step 204. Subsequently, the compression algorithm used to compress the program is determined in a process step 206. Usually,—from a cost perspective—one recording apparatus will use only one compression algorithm, so this step can be dispersed with for these embodiments.

Having determined the compression algorithm, the quality of the compression process is determined in a step 208. In various known digital video recorders like the TIVO® personal video recorder and the DVD+RW recorder of Royal Philips Electronics, a user is enabled to adjust the quality level of video compression. Given a pre-determined compression algorithm, the quality level set determines the size of the stream of audio-visual data to be stored to a large extent.

In the next step 210, the complexity of the stream to be recorded is determined. In a preferred embodiment of the invention, a parameter indicating the complexity of the stream of audio-visual data is embedded in meta-data associated with the stream of audio-visual data to be recorded and received together with the stream of audio-visual data. For example, the TV-Anytime data of the program to be recorded comprises a parameter indicating the complexity of the program.

Having determined duration, compression technique and the complexity of the program to be recorded, the size of the compressed stream is calculated in a process step 212. For example, when the program has a duration of 1 hour and 15 minutes, the maximum bit rate with the compression algorithm and compression quality used is 4 Mb (megabit) per second and the complexity factor is 0.6, while the size of the final stream to be stored is (75×60×4.2²⁰×0.6)/8=1350 Mb (megabyte).

Finally, in a terminator 214, the result of the calculation in the step 212 is returned to the parent process that has called the sub-routine.

It will be obvious to any person skilled in the art that steps 204 through 210 do not necessarily have to be performed in the sequence as depicted in the flow chart 200. Also other variations are possible without departing from the scope of the invention.

In an advantageous embodiment of the invention, the size of the stream of audio-visual data is determined prior to the reception of the stream of audio-visual data. In this way, one contiguous area in the memory 114 (FIG. 1) may be allocated for storage of the stream. This is advantageous for embodiments of the invention where the memory 114 is a disc-based memory. When the stream is stored in one contiguous area, it can be retrieved continuously, without sweeping of the pick up unit. This improves the performance of the disc-based memory, because no data can be read when sweeping the pick-up unit. For this embodiment, the signal 150 (FIG. 1) provides the information on the complexity of the stream prior to providing the stream of audio-visual data.

Finally, it should be mentioned that determination of the size of the stream of audio-visual data prior to the reception and storage of the stream is not necessary. It would also be possible to provide the information on the complexity of the stream of audio-visual data in the first half of the stream. When either the duration of the stream, the compression algorithm and/or the compression quality are known, already a first rough estimate may be provided on the final size of the compressed and stored stream. This is followed by a more accurate estimate in the course of the program, using the method according to the invention.

The invention may be summarized as follows:

When a stream of audio-visual data like a television program is recorded with a digital video recorder comprising a compression engine for compressing the stream prior to storage using a variable bit-rate compression technique, the size of the full stream to be stored is unknown. The invention provides a method which solves this problem by providing information on the complexity of the stream to be stored. With this information, combined with information on the duration of the stream of audio-visual data and the compression algorithm used to compress the stream, the amount of storage space to be reserved for storing the stream of audio-visual data can be determined.

1. A method of determining the size of a compressed stream of audio-visual data, wherein the compression has taken place by means of variable bit-rate compression, the method comprising the step of determining the duration of the stream of audio-visual data, characterized in that the method further comprises the following steps:
(a) determining the compression technique;
(b) determining the complexity of the stream of audio-visual data; and
(c) determining the size of the stream of audio-visual data using the information determined in the previous steps.

2. A method as claimed in to claim 1, wherein the complexity of the stream of audio-visual data is indicated by an average bit rate at a given compression technique.

3. A method as claimed in to claim 1, wherein the complexity of the stream of audio-visual data is indicated by a factor of information redundancy in the stream of audio-visual data.

4. A method as claimed in to claim 1, wherein the complexity of the stream of audio-visual data is derived from meta-data associated with the stream of audio-visual data.

5. A method as claimed in to claim 1, wherein the duration of the stream of audio-visual data is derived from meta-data associated with the stream of audio-visual data.

6. A method as claimed in to claim 1, wherein the duration of the stream of audio-visual data is derived from an apparatus for storing audio-visual data, the apparatus being pre-programmed to store the stream of audio-visual data.

7. A method as claimed in to claim 6, wherein the apparatus is pre-programmed to record the stream of audio-visual data from a predetermined start time until a pre-determined end time.

8. A method as claimed in to claim 1, wherein the size of the stream of audio-visual data is determined prior to reception of the full stream of audio-visual data.

9. A method as claimed in to claim 1, wherein the stream of audio-visual data is analog and digitized prior to the compression.

10. A circuit for determining the size of a compressed stream of audio-visual data, wherein the compression has taken place by means of variable bit-rate compression, the circuit comprising a central processing unit conceived to determine the duration of the stream of audio-visual data, characterized in that the central processing unit is further conceived to:
(a) determine the compression technique used to compress the stream of audio-visual data;
(b) determine the complexity of the stream of audio-visual data; and
(c) determine the size of the stream of audio-visual data using the information on the duration of the stream of audio-visual data, the compression technique used to compress the stream of audio-visual data and the complexity of the stream of audio-visual data.

11. An apparatus for storing a stream of audio-visual data, the apparatus comprising a compression controller for compressing the stream of audio-visual data prior to storage of the stream of audio-visual data and the circuit as claimed in to claim 10.

12. A signal carrying a stream of audio-visual data and meta-data associated with the stream of audio-visual data, characterized in that the meta-data comprises information on the complexity of the stream of audio-visual data.

13. A signal according to claim 12, wherein the information on the complexity of the stream of audio-visual data comprises an average bit rate of at least a part of the stream of audio-visual data.

14. A signal according to claim 12, wherein the information on the complexity of the stream of audio-visual data comprises a factor of information redundancy in the stream of audio-visual data.

15. A signal according to claim 12, wherein the information on the complexity of the stream of audio-visual data is provided prior to providing the stream of audio-visual data.
